(19) United States
(12) Patent Application Publication
(10) Pub. No.: US 2015/0315370 A1
(43) Pub. Date: Nov. 5, 2015

(54) SEMICONDUCTIVE ROLLER

(71) Applicants: SUMITOMO RUBBER INDUSTRIES, LTD., Kobe-shi (JP); TAKAMATSU TEISAN CO., LTD., Takamatsu-shi (JP)

(72) Inventors: Kenichi KURODA, Kobe-shi (JP); Kazutaka MORI, Takamatsu-shi (JP); Atsushi EGUCHI, Takamatsu-shi (JP)

(73) Assignees: TAKAMATSU TEISAN CO., LTD., Takamatsu-shi (JP); SUMITOMO RUBBER INDUSTRIES, LTD., Kobe-shi (JP)

(21) Appl. No.: 14/658,991

(22) Filed: Mar. 16, 2015

(30) Foreign Application Priority Data
May 2, 2014 (JP) 2014-095292

(51) Int. Cl. C08L 11/00; C08L 9/02; C08L 9/06; C08L 71/03

(52) U.S. Cl. CPC C08L 11/00; C08L 71/03; C08L 9/02; C08L 9/06

(57) ABSTRACT

To provide a semiconductive roller which, when being used as a developing roller in combination with a positively chargeable toner, is capable of suppressing adhesion of the toner thereto to suppress reduction of image density, charging the toner to a higher toner charging level to ensure formation of higher-quality images, and suppressing reduction of toner charging level even after continuous repeated image formation to thereby suppress fogging of formed images for a longer period of time.

The semiconductive roller (1) is made of a crosslinking product of a rubber composition containing at least an epichlorohydrin rubber and a chloroprene rubber, and has a fluorinated film (5) formed in an outer peripheral surface (4) thereof by treatment with fluorine gas.

### TECHNICAL FIELD

The present invention relates to a semiconductive roller which is advantageously used as a developing roller or the like in an electrophotographic image forming apparatus.

### BACKGROUND ART

In an electrophotographic image forming apparatus such as a laser printer, an electrostatic copying machine, a plain paper facsimile machine or a printer-copier-facsimile multifunction machine, an electrostatic latent image formed on a surface of a photoreceptor body by electrically charging the photoreceptor surface and exposing the photoreceptor surface to light is developed into a toner image with a charged toner, and a developing roller is used for the development.

It is proposed that an outermost layer of an organic polymer containing fluorine atoms is formed on an outer peripheral surface of the developing roller in order to reduce the friction of the outer peripheral surface of the developing roller to suppress adhesion of the toner to the outer peripheral surface and hence to suppress reduction in image density.

The outermost layer of the organic polymer is formed by applying a coating liquid of the organic polymer on the outer peripheral surface of the developing roller by a spraying method, a dipping method or the like and then drying the resulting coating. However, contamination with dust and other foreign matter, uneven thickness and other various inconveniences are liable to occur during the formation of the outermost layer. These inconveniences directly affect the quality of formed images.

Where fluorine atoms are introduced into the outermost layer, for example, by using an organic polymer containing —CF═O groups, the roller resistance is liable to significantly vary due to environmental changes. This is because the —CF═O groups are hydrophilic.

For example, no problem occurs in an ordinary-temperature and ordinary-humidity environment at a temperature of 23° C. at a relative humidity of 55%. Where an image is formed in a lower-temperature and lower-humidity environment at a temperature of 10° C. at a relative humidity of 30%, however, the image is liable to have a lower image density.

To cope with this, Patent Document 1 contemplates that a developing roller made of a crosslinking product of a rubber composition is treated with fluorine gas whereby a fluorinated film is formed in an outer peripheral surface of the developing roller.

Since the formation of the fluorinated film is achieved by fluorination of a rubber component itself of the rubber composition in the outer peripheral surface of the developing roller, there is no possibility that the fluorinated film is contaminated with foreign matter such as dust during the formation of the fluorinated film. Further, the fluorination is allowed to uniformly proceed in the outer peripheral surface of the developing roller by exposing the developing roller to the fluorine gas, thereby preventing the fluorinated film from suffering from uneven thickness.

### CITATION LIST

### Patent Document

[PATENT DOCUMENT 1] JP-2009-58631-A

### SUMMARY OF THE INVENTION

### Problem to be Solved by the Invention

Where the formation of the fluorinated film in the outer peripheral surface of the developing roller is achieved by the fluorine gas treatment, the aforementioned effects are provided. Further, the fluorine has a negative charging tendency and, therefore, where a positively chargeable toner is used in combination with the developing roller formed with the fluorinated film, the developing roller is expected to be capable of charging the toner to a higher charge level (a higher toner charging level) to form higher-quality images. In addition, the developing roller is expected to prevent reduction of the toner charging level even after continuous repeated image formation to thereby suppress the fogging of formed images for a longer period of time.

However, a developing roller made of a crosslinking product of a rubber composition containing only two types of rubbers including an epichlorohydrin rubber and an acrylonitrile butadiene rubber as a rubber component cannot provide the aforementioned effects as confirmed in Patent Document 1.

It is an object of the present invention to provide a semiconductive roller which, when being used as a developing roller in combination with a positively chargeable toner, is capable of suppressing the adhesion of the toner thereto to suppress the reduction of the image density, charging the toner to a higher toner charging level to ensure the formation of higher-quality images, and suppressing the reduction of the toner charging level even after the continuous repeated image formation to thereby suppress the fogging of formed images for a longer period of time.

### Solution to Problem

According to the present invention, there is provided a semiconductive roller made of a crosslinking product of a rubber composition containing a rubber component including an epichlorohydrin rubber and a chloroprene rubber (CR), and having a fluorinated film formed in an outer peripheral surface thereof by treatment with fluorine gas.

### Effects of the Invention

According to studies conducted by the inventor of the present invention, the semiconductive roller made of the crosslinking product of the rubber composition containing the epichlorohydrin rubber and the CR in combination as the rubber component and having the fluorinated film formed in the outer peripheral surface thereof by the fluorine gas treatment may be used as a developing roller in combination with a positively chargeable toner and, in this case, is capable of charging the toner to a higher toner charging level to ensure the formation of higher-quality images. In addition, the semiconductive roller prevents the significant reduction of the toner charging level even after the continuous repeated image formation, thereby suppressing the fogging of formed images for a longer period of time.

This is supposedly because the flexibility of the semiconductive roller is improved by the use of the CR in combination with the epichlorohydrin rubber to provide a proper nip width with respect to a photoreceptor body or the like.

Patent Document 1 describes the use of the chloroprene rubber as the rubber component, but does not teach that, where the chloroprene rubber is used in combination with the epichlorohydrin rubber, the aforementioned effects can be provided.

### BRIEF DESCRIPTION OF THE DRAWING

FIG. 1 is a perspective view illustrating an exemplary semiconductive roller according to an embodiment of the present invention.

### EMBODIMENTS OF THE INVENTION

A semiconductive roller according to the present invention is made of a crosslinking product of a rubber composition containing a rubber component including at least an epichlorohydrin rubber and a chloroprene rubber (CR), and has a fluorinated film formed in an outer peripheral surface thereof by treatment with fluorine gas.

According to the present invention, the semiconductive roller made of the crosslinking product of the rubber composition containing at least the aforementioned two types of rubbers in combination as the rubber component and having the fluorinated film formed in the outer peripheral surface thereof by the fluorine gas treatment may be used as a developing roller in combination with a positively chargeable toner and, in this case, is capable of suppressing the adhesion of the toner thereto to suppress the reduction of the image density, and charging the toner to a higher toner charging level to ensure the formation of higher-quality images. In addition, the semiconductive roller prevents the significant reduction of the toner charging level even after the continuous repeated image formation, thereby suppressing the fogging of formed images for a longer period of time.

The inventive semiconductive roller is preferably produced by blending the rubber component including at least the aforementioned two types of rubbers, a crosslinking component for crosslinking the rubber component and the like to prepare a rubber composition, forming the rubber composition into a tubular body, crosslinking the rubber composition of the tubular body, and then treating the tubular body with the fluorine gas.

For production of the semiconductive roller at a higher productivity at lower costs and for improvement of the durability and the compression set of the semiconductive roller, the inventive semiconductive roller preferably has a non-porous single layer structure.

The single layer structure herein means that the semiconductive roller includes a single layer formed from the rubber composition, not counting the fluorinated film formed by the fluorine gas treatment.

### <Rubber Component>

As described above, the two types of rubbers including the epichlorohydrin rubber and the CR are used in combination as the rubber component.

In addition to the two types of rubbers, at least one rubber selected from the group consisting of an acrylonitrile butadiene rubber (NBR) and a styrene butadiene rubber (SBR) may be used.

It is particularly preferred to use three types of rubbers including the epichlorohydrin rubber, the CR and the NBR in combination, or to use three types of rubbers including the epichlorohydrin rubber, the CR and the SBR.

Two or more of the epichlorohydrin rubber, the CR and the NBR, or two or more of the epichlorohydrin rubber, the CR and the SBR may be used in combination.

### (Epichlorohydrin Rubber)

The epichlorohydrin rubber functions to impart the semiconductive roller with ion conductivity.

Examples of the epichlorohydrin rubber include epichlorohydrin homopolymers, epichlorohydrin-ethylene oxide bipolymers (ECO), epichlorohydrin-propylene oxide bipolymers, epichlorohydrin-allyl glycidyl ether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used either alone or in combination.

Of the aforementioned examples, the ethylene oxide-containing copolymers, particularly the ECO and/or the GECO are preferred as the epichlorohydrin rubber.

These copolymers preferably each have an ethylene oxide content of not less than 30 mol % and not greater than 95 mol %, particularly preferably not less than 60 mol % and not greater than 80 mol %.

Ethylene oxide functions to reduce the roller resistance of the semiconductive roller. If the ethylene oxide content is less than the aforementioned range, however, it will be impossible to sufficiently provide the roller resistance reducing function and hence to sufficiently reduce the roller resistance of the semiconductive roller.

If the ethylene oxide content is greater than the aforementioned range, on the other hand, ethylene oxide is liable to be crystallized, whereby the segment motion of molecular chains is hindered to adversely increase the roller resistance of the semiconductive roller.

Further, the rubber composition is liable to have a higher viscosity when being heat-melted after the rubber component and other ingredients are blended for preparation of the rubber composition, or when being heat-melted for forming the prepared rubber composition into a tubular body before the crosslinking. This may reduce the working efficiency in these operations. Further, the semiconductive roller is liable to have a higher hardness after the crosslinking.

The ECO has an epichlorohydrin content that is a balance obtained by subtracting the ethylene oxide content from the total. That is, the epichlorohydrin content is preferably not less than 5 mol % and not greater than 70 mol %, particularly preferably not less than 20 mol % and not greater than 40 mol %.

The GECO preferably has an allyl glycidyl ether content of not less than 0.5 mol % and not greater than 10 mol %, particularly preferably not less than 2 mol % and not greater than 6 mol %.

Allyl glycidyl ether per se functions as side chains of the copolymer to provide a free volume, whereby the crystallization of ethylene oxide is suppressed to reduce the roller resistance of the semiconductive roller. However, if the allyl glycidyl ether content is less than the aforementioned range, it will be impossible to provide the roller resistance reducing function and hence to sufficiently reduce the roller resistance of the semiconductive roller.

Allyl glycidyl ether also functions as crosslinking sites during the crosslinking of the GECO. Therefore, if the allyl glycidyl ether content is greater than the aforementioned range, the crosslinking density of the GECO is increased, whereby the segment motion of molecular chains is hindered. This may adversely increase the roller resistance of the semiconductive roller. Further, the semiconductive roller is liable to suffer from reduction in tensile strength, fatigue resistance and flexural resistance.

The GECO has an epichlorohydrin content that is a balance obtained by subtracting the ethylene oxide content and the allyl glycidyl ether content from the total. That is, the epichlorohydrin content is preferably not less than 4.5 mol % and not greater than 65 mol %, particularly preferably not less than 15 mol % and not greater than 40 mol %.

Examples of the GECO include copolymers of the three comonomers described above in a narrow sense, as well as known modification products obtained by modifying an epichlorohydrin-ethylene oxide copolymer (ECO) with allyl glycidyl ether. In the present invention, any of these modification products may be used as the GECO.

Where three types of rubbers including the epichlorohydrin rubber, the CR and the NBR are used in combination, the proportion of the epichlorohydrin rubber to be blended is preferably not less than 30 parts by mass and not greater than 70 parts by mass based on 100 parts by mass of the overall rubber component.

Where three types of rubbers including the epichlorohydrin rubber, the CR and the SBR are used in combination, the proportion of the epichlorohydrin rubber to be blended is preferably not less than 20 parts by mass and not greater than 60 parts by mass based on 100 parts by mass of the overall rubber component.

If the proportion of the epichlorohydrin rubber is less than the aforementioned range in either of the aforementioned cases, it will be impossible to impart the semiconductive roller with proper ion conductivity.

If the proportion of the epichlorohydrin rubber is greater than the aforementioned range, on the other hand, the proportion of the CR is relatively reduced. Therefore, it will be impossible to sufficiently provide the effects of the combinational use of the CR. That is, where the semiconductive roller having the fluorinated film formed in the outer peripheral surface thereof is used as a developing roller, it will be impossible to prevent the significant reduction of the toner charging level after the continuous repeated image formation and hence to suppress the fogging of formed images for a longer period of time.

### (CR)

The CR is synthesized, for example, by polymerizing chloroprene by an emulsion polymerization method. According to the type of a molecular weight adjusting agent to be used for the emulsion polymerization, CRs are classified into a sulfur modification type and a non-sulfur-modification type. In the present invention, either type of CRs is usable.

The sulfur modification type CRs are each prepared by plasticizing a copolymer of chloroprene and sulfur (molecular weight adjusting agent) with thiuram disulfide or the like to adjust the viscosity of the copolymer to a predetermined viscosity level.

The non-sulfur-modification type CRs are classified into a mercaptan modification type, a xanthogen modification type and the like.

The mercaptan modification type CRs are each synthesized in substantially the same manner as the sulfur modification type CRs, for example, by using an alkyl mercaptan such as n-dodecyl mercaptan, tert-dodecyl mercaptan or octyl mercaptan as the molecular weight adjusting agent. The xanthogen modification type CRs are each synthesized in substantially the same manner as the sulfur modification type CRs by using an alkyl xanthogen compound as the molecular weight adjusting agent.

Further, the CRs are classified into a lower crystallization speed type, an intermediate crystallization speed type and a higher crystallization speed type according to the crystallization speed.

In the present invention, any of the aforementioned types of CRs may be used. Particularly, CRs of the non-sulfur-modification type and the lower crystallization speed type are preferred, which may be used either alone or in combination.

Further, a rubber prepared by copolymerizing chloroprene and other comonomer may be used as the CR.

Examples of the other comonomer include 2,3-dichloro-1,3-butadiene, 1-chloro-1,3-butadiene, styrene, acrylonitrile, methacrylonitrile, isoprene, butadiene, acrylic acid, acrylates, methacrylic acid and methacrylates, which may be used either alone or in combination.

Where three types of rubbers including the epichlorohydrin rubber, the CR and the NBR are used in combination as the rubber component or where three types of rubbers including the epichlorohydrin rubber, the CR and the SBR are used in combination as the rubber component, the proportion of the CR to be blended is preferably not less than 10 parts by mass and not greater than 30 parts by mass based on 100 parts by mass of the overall rubber component.

If the proportion of the CR is less than the aforementioned range, it will be impossible to sufficiently provide the effects of the combinational use of the CR. That is, where the semiconductive roller having the fluorinated film formed in the outer peripheral surface thereof is used as a developing roller, it will be impossible to prevent the significant reduction of the toner charging level after the continuous repeated image formation and hence to suppress the fogging of formed images for a longer period of time.

If the proportion of the CR is greater than the aforementioned range, on the other hand, the proportion of the epichlorohydrin rubber is relatively reduced, making it impossible to impart the semiconductive roller with proper ion conductivity.

### (NBR)

The NBR is a rubber prepared by copolymerizing acrylonitrile and butadiene. Any of a lower acrylonitrile content type NBR having an acrylonitrile content of not greater than 24%, an intermediate acrylonitrile content type NBR having an acrylonitrile content of 25 to 30%, an intermediate to higher acrylonitrile content type NBR having an acrylonitrile content of 31 to 35%, a higher acrylonitrile content type NBR having an acrylonitrile content of 36 to 42% and a very high acrylonitrile content type NBR having an acrylonitrile content of not less than 43% may be used as the NBR. Particularly, where a lower acrylonitrile content type NBR having a lower specific gravity is used, the specific gravity of the semiconductive roller can be reduced for weight reduction.

These NBRs may be used either alone or in combination.

Where three types of rubbers including the epichlorohydrin rubber, the CR and the NBR are used in combination, the proportion of the NBR to be blended is a balance obtained by subtracting the proportions of the epichlorohydrin rubber and the CR from the total.

### (SBR)

Usable as the SBR are various SBRs synthesized by copolymerizing styrene and 1,3-butadiene by an emulsion polymerization method, a solution polymerization method and other various polymerization methods. The SBRs include those of an oil-extension type having flexibility controlled by addition of an extension oil, and those of a non-oil-extension type containing no extension oil. Either type of SBRs is usable.

According to a combined styrene amount, the SBRs are classified into a higher styrene content type, an intermediate styrene content type and a lower styrene content type, and any of these types of SBRs is usable. Physical properties of the semiconductive roller can be controlled by changing the combined styrene amount and the crosslinking degree.

These SBRs may be used either alone or in combination.

Where three types of rubbers including the epichlorohydrin rubber, the CR and the SBR are used in combination, the proportion of the SBR to be blended is a balance obtained by subtracting the proportions of the epichlorohydrin rubber and the CR from the total.

<Crosslinking Component>

The crosslinking component for crosslinking the rubber component includes a crosslinking agent, an accelerating agent and the like.

Examples of the crosslinking agent include a sulfur crosslinking agent, a thiourea crosslinking agent, a triazine derivative crosslinking agent, a peroxide crosslinking agent and various monomers, which may be used either alone or in combination. Among these crosslinking agents, the sulfur crosslinking agent is preferred.

Examples of the sulfur crosslinking agent include sulfur powder and organic sulfur-containing compounds. Examples of the organic sulfur-containing compounds include tetramethylthiuram disulfide and N,N-dithiobismorpholine. Sulfur such as the sulfur powder is particularly preferred.

The proportion of the sulfur to be blended is preferably not less than 0.2 parts by mass and not greater than 5 parts by mass, particularly preferably not less than 1 part by mass and not greater than 3 parts by mass, based on 100 parts by mass of the overall rubber component.

If the proportion of the sulfur is less than the aforementioned range, the rubber composition is liable to have a lower crosslinking speed as a whole, requiring a longer period of time for the crosslinking to reduce the productivity of the semiconductive roller. If the proportion of the sulfur is greater than the aforementioned range, the semiconductive roller is liable to have a higher compression set after the crosslinking, or an excess amount of the sulfur is liable to bloom on the outer peripheral surface of the semiconductive roller.

Examples of the accelerating agent include inorganic accelerating agents such as lime, magnesia (MgO) and litharge (PbO), and organic accelerating agents, which may be used either alone or in combination.

Examples of the organic accelerating agents include: guanidine accelerating agents such as 1,3-di-o-tolylguanidine, 1,3-diphenylguanidine, 1-o-tolylbiguanide and a di-o-tolylguanidine salt of dicatechol borate; thiazole accelerating agents such as 2-mercaptobenzothiazole and di-2-benzothiazyl disulfide; sulfenamide accelerating agents such as N-cyclohexyl-2-benzothiazylsulfenamide; thiuram accelerating agents such as tetramethylthiuram monosulfide, tetramethylthiuram disulfide, tetraethylthiuram disulfide and dipentamethylenethiuram tetrasulfide; and thiourea accelerating agents such as ethylenethiourea, tetramethylthiourea and trimethylthiourea, which may be used either alone or in combination.

According to the type of the crosslinking agent to be used, at least one optimum accelerating agent is selected from the various accelerating agents for use in combination with the crosslinking agent. Different types of accelerating agents have different crosslinking accelerating mechanisms and, therefore, are preferably used in combination. The proportions of the accelerating agents to be used in combination may be properly determined, and are preferably not less than 0.1 part by mass and not greater than 2 parts by mass based on 100 parts by mass of the overall rubber component.

The crosslinking component may further include an acceleration assisting agent.

Examples of the acceleration assisting agent include: metal compounds such as zinc white (zinc oxide); fatty acids such as stearic acid, oleic acid and cotton seed fatty acids; and other conventionally known acceleration assisting agents, which may be used either alone or in combination.

The proportion of the acceleration assisting agent to be blended may be properly determined according to the types and combination of the rubbers of the rubber component, and the types and combination of the crosslinking agent and the accelerating agent.

<Other Ingredients>

As required, various additives may be added to the rubber composition. Examples of the additives include an acid accepting agent, a plasticizing agent, a processing aid, a degradation preventing agent, a filler, an anti-scorching agent, a UV absorbing agent, a lubricant, a pigment, an anti-static agent, a flame retarder, a neutralizing agent, a nucleating agent, a co-crosslinking agent and the like.

In the presence of the acid accepting agent, chlorine-containing gases generated from the epichlorohydrin rubber and the CR during the crosslinking of the rubber component are prevented from remaining in the semiconductive roller. Thus, the acid accepting agent functions to prevent the inhibition of the crosslinking and the contamination of the photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where the hydrotalcites are used in combination with magnesium oxide or potassium oxide, a higher acid accepting effect can be provided, thereby more reliably preventing the contamination of the photoreceptor body.

The proportion of the acid accepting agent to be blended is preferably not less than 0.2 parts by mass and not greater than 5 parts by mass, particularly preferably not less than 0.5 parts by mass and not greater than 3 parts by mass, based on 100 parts by mass of the overall rubber component.

If the proportion of the acid accepting agent is less than the aforementioned range, it will be impossible to sufficiently provide the effect of the blending of the acid accepting agent. If the proportion of the acid accepting agent is greater than the aforementioned range, the semiconductive roller is liable to have an increased hardness after the crosslinking.

Examples of the plasticizing agent include plasticizers such as dibutyl phthalate (DBP), dioctyl phthalate (DOP) and tricresyl phosphate, and waxes such as polar waxes. Examples of the processing aid include fatty acids such as stearic acid.

The proportion of the plasticizing agent and/or the processing aid to be blended is preferably not greater than 5 parts by mass based on 100 parts by mass of the overall rubber component. This prevents the contamination of the photoreceptor body, for example, when the semiconductive roller is mounted in an image forming apparatus or when the image forming apparatus is operated. For this purpose, it is particularly preferred to use any of the polar waxes as the plasticizing agent.

Examples of the degradation preventing agent include various anti-aging agents and anti-oxidants.

The anti-oxidants serve to reduce the environmental dependence of the roller resistance of the semiconductive roller and to suppress the increase in roller resistance during continuous energization of the semiconductive roller. Examples of the anti-oxidants include nickel diethyldithiocarbamate (NOCRAC (registered trade name) NEC-P available from Ouchi Shinko Chemical Industrial Co., Ltd.) and nickel dibutyldithiocarbamate (NOCRAC NBC available from Ouchi Shinko Chemical Industrial Co., Ltd.)

Examples of the filler include zinc oxide, silica, carbon, carbon black, clay, talc, calcium carbonate, magnesium carbonate and aluminum hydroxide, which may be used either alone or in combination.

The mechanical strength and the like of the semiconductive roller can be improved by blending the filler.

The proportion of the filler to be blended is preferably not less than 2 parts by mass and not greater than 25 parts by mass, particularly preferably not greater than 20 parts by mass, based on 100 parts by mass of the overall rubber composition.

The semiconductive roller may be imparted with electron conductivity by blending an electrically conductive carbon black as the filler.

A preferred example of the electrically conductive carbon black is HAF. The HAF can be evenly dispersed in the rubber composition to impart the semiconductive roller with more uniform electron conductivity.

The proportion of the electrically conductive carbon black to be blended is preferably not less than 1 part by mass and not greater than 3 parts by mass based on 100 parts by mass of the overall rubber component.

Examples of the anti-scorching agent include N-cyclohexylthiophthalimide, phthalic anhydride, N-nitrosodiphenylamine and 2,4-diphenyl-4-methyl-1-pentene, which may be used either alone or in combination. Particularly, N-cyclohexylthiophthalimide is preferred.

The proportion of the anti-scorching agent to be blended is preferably not less than 0.1 part by mass and not greater than 5 parts by mass, particularly preferably not greater than 1 part by mass, based on 100 parts by mass of the overall rubber component.

The co-crosslinking agent serves to crosslink itself as well as the rubber component to increase the overall molecular weight.

Examples of the co-crosslinking agent include ethylenically unsaturated monomers typified by methacrylic esters, metal salts of methacrylic acid and acrylic acid, polyfunctional polymers utilizing functional groups of 1,2-polybutadienes, and dioximes, which may be used either alone or in combination.

Examples of the ethylenically unsaturated monomers include:

(a) monocarboxylic acids such as acrylic acid, methacrylic acid and crotonic acid;
(b) dicarboxylic acids such as maleic acid, fumaric acid and itaconic acid;
(c) esters and anhydrides of the unsaturated carboxylic acids (a) and (b);
(d) metal salts of the monomers (a) to (c);
(e) aliphatic conjugated dienes such as 1,3-butadiene, isoprene and 2-chloro-1,3-butadiene; (f) aromatic vinyl compounds such as styrene, α-methylstyrene, vinyltoluene, ethylvinylbenzene and divinylbenzene;
(g) vinyl compounds such as triallyl isocyanurate, triallyl cyanurate and vinylpyridine each having a hetero ring; and
(h) cyanovinyl compounds such as (meth)acrylonitrile and α-chloroacrylonitrile, acrolein, formyl sterol, vinyl methyl ketone, vinyl ethyl ketone and vinyl butyl ketone. These ethylenically unsaturated monomers may be used either alone or in combination.

Monocarboxylic acid esters are preferred as the esters (c) of the unsaturated carboxylic acids.

Specific examples of the monocarboxylic acid esters include:

alkyl(meth)acrylates such as methyl(meth)acrylate, ethyl(meth)acrylate, n-propyl(meth)acrylate, i-propyl(meth)acrylate, n-butyl(meth)acrylate, i-butyl(meth)acrylate, n-pentyl(meth)acrylate, i-pentyl(meth)acrylate, n-hexyl(meth)acrylate, cyclohexyl(meth)acrylate, 2-ethylhexyl(meth)acrylate, octyl(meth)acrylate, i-nonyl(meth)acrylate, tert-butylcyclohexyl(meth)acrylate, decyl(meth)acrylate, dodecyl(meth)acrylate, hydroxymethyl(meth)acrylate and hydroxyethyl(meth)acrylate;

aminoalkyl(meth)acrylates such as aminoethyl(meth)acrylate, dimethylaminoethyl(meth)acrylate and butylaminoethyl(meth)acrylate;

(meth)acrylates such as benzyl(meth)acrylate, benzoyl(meth)acrylate and aryl(meth)acrylates each having an aromatic ring;

(meth)acrylates such as glycidyl(meth)acrylate, methaglycidyl(meth)acrylate and epoxycyclohexyl(meth)acrylate each having an epoxy group;

(meth)acrylates such as N-methylol(meth)acrylamide, γ-(meth)acryloxypropyltrimethoxysilane and tetrahydrofurfuryl methacrylate each having a functional group; and

polyfunctional (meth)acrylates such as ethylene glycol di(meth)acrylate, trimethylolpropane tri(meth)acrylate, ethylene dimethacrylate (EDMA), polyethylene glycol dimethacrylate and isobutylene ethylene dimethacrylate. These monocarboxylic acid esters may be used either alone or in combination.

The rubber composition containing the ingredients described above can be prepared in a conventional manner. First, the rubbers for the rubber component are blended in the predetermined proportions, and the resulting rubber component is simply kneaded. After additives other than the crosslinking component are added to and kneaded with the rubber component, the crosslinking component is finally added to and further kneaded with the resulting mixture. Thus, the rubber composition is provided. A kneader, a Banbury mixer, an extruder or the like, for example, is usable for the kneading.

### <<Semiconductive Roller>>

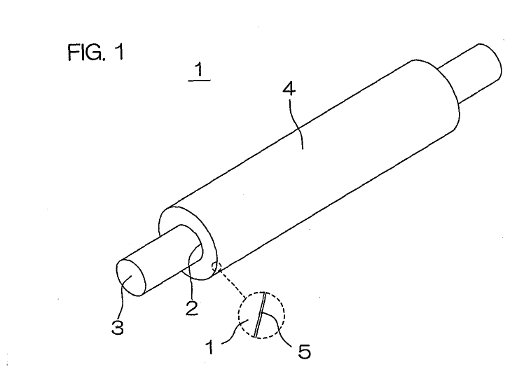

FIG. 1 is a perspective view illustrating an exemplary semiconductive roller according to one embodiment of the present invention.

Referring to FIG. 1, the semiconductive roller 1 according to this embodiment is a tubular body of a non-porous single layer structure made of a crosslinking product of the rubber composition described above, and a shaft 3 is inserted through and fixed to a center through-hole 2 of the semiconductive roller 1.

The shaft 3 is a unitary member made of a metal such as aluminum, an aluminum alloy or a stainless steel.

The shaft 3 is electrically connected to and mechanically fixed to the semiconductive roller 1, for example, via an electrically conductive adhesive agent. Alternatively, a shaft having an outer diameter greater than the inner diameter of the through-hole 2 is used as the shaft 3, and press-inserted into the through-hole 2 to be electrically connected to and mechanically fixed to the semiconductive roller 1. Thus, the shaft 3 and the semiconductive roller 1 are unitarily rotatable.

As shown in FIG. 1 on an enlarged scale, the semiconductive roller 1 has a fluorinated film 5 formed in an outer peripheral surface 4 thereof by treatment with fluorine gas.

Where the semiconductive roller is used as a developing roller in combination with a positively chargeable toner, as described above, the formation of the fluorinated film 5 suppresses the adhesion of the toner to the semiconductive roller to suppress the reduction of the image density, and makes it possible to charge the toner to a higher toner charging level to ensure the formation of higher-quality images. In addition, the semiconductive roller prevents the significant reduction of the toner charging level even after the continuous repeated image formation, thereby suppressing the fogging of formed images for a longer period of time.

### <Production of Semiconductive Roller>

The semiconductive roller 1 is produced by extruding the prepared rubber composition into a tubular body by means of an extruder, cutting the tubular body to a predetermined length, and crosslinking the rubber composition of the resulting tubular body in a vulcanization can by pressure and heat.

Then, the tubular body thus crosslinked is heated in an oven for secondary crosslinking. Subsequently, the resulting tubular body is cooled, and then polished to a predetermined outer diameter.

The shaft 3 may be inserted into and fixed to the through-hole 2 at any time between the cutting of the tubular body and the polishing of the tubular body.

However, the tubular body is preferably secondarily crosslinked and polished with the shaft 3 inserted in the through-hole 2 thereof after the cutting. This prevents the warpage and the deformation of the semiconductive roller 1 which may otherwise occur due to the expansion and the contraction of the tubular body during the secondary crosslinking. Further, the tubular body may be polished while being rotated about the shaft 3. This improves the polishing process efficiency, and suppresses the deflection of the outer peripheral surface 4.

Where the outer diameter of the shaft 3 is greater than the inner diameter of the through-hole 2, as described above, the shaft 3 may be press-inserted into the through-hole 2. Alternatively, the shaft 3 may be inserted into the through-hole 2 of the tubular body before the secondary crosslinking, and fixed to the tubular body with an electrically conductive thermosetting adhesive agent.

In the latter case, the thermosetting adhesive agent is cured by the heating in the oven during the secondary crosslinking of the tubular body, whereby the shaft 3 is electrically connected to and mechanically fixed to the semiconductive roller 1.

In the former case, the electrical connection and the mechanical fixing are achieved upon the insertion of the shaft 3.

(Treatment with Fluorine Gas)

The fluorinated film 5 is formed by treating the semiconductive roller 1 with the fluorine gas.

For example, a direct fluorination method using fluorine gas alone or using a gas mixture of fluorine gas and an inert gas such as nitrogen gas or a plasma fluorination method using a gaseous fluorine-containing compound such as CF₄, NF₃ or SF₆ may be employed for the fluorine gas treatment.

In the direct fluorination method, for example, the semiconductive roller 1 is set in a closed chamber with the shaft 3 supported by the chamber. After the chamber is vacuum-evacuated by means of a vacuum pump and purged with an inert gas such as nitrogen gas several times, the fluorine gas or the gas mixture is fed into the chamber to be brought into contact with the semiconductive roller 1. After a lapse of a predetermined period, the chamber is vacuum-evacuated and purged with the inert gas such as nitrogen gas several times for removal of unreacted fluorine gas and reaction byproducts, and the semiconductive roller 1 is taken out of the chamber.

Fluorine molecules of the fluorine gas fed into the chamber are easily dissociated into fluorine atoms, and the fluorine atoms resulting from the dissociation are highly reactive. Therefore, the fluorine atoms react with the rubber component of the rubber composition in the outer peripheral surface 4 of the semiconductive roller 1 for fluorination. Thus, the fluorinated film 5 is formed in the outer peripheral surface 4.

If oxygen gas coexists with the fluorine gas in the chamber, —CF═O groups are formed in the rubber surface, making it impossible to properly form the fluorinated film.

In order to remove the oxygen gas from the chamber as much as possible, the chamber is vacuum-evacuated and purged with the inert gas before the treatment. Alternatively, the removal of the oxygen gas may be achieved by feeding the inert gas such as nitrogen gas into the chamber or by performing any other operation.

The removal of the unreacted fluorine gas and the reaction byproducts after the treatment may be achieved by performing an operation other than the vacuum evacuation.

In the fluorine gas treatment method such as the direct fluorination method, as described above, the fluorinated film 5 is formed by the fluorination of the rubber component itself of the rubber composition in the outer peripheral surface 4 of the semiconductive roller 1. Therefore, the fluorine gas treatment method is free from the problems associated with the prior art outermost layer of the organic polymer, and the fluorinated film is highly uniform in thickness and the like.

In order to efficiently fluorinate the outer peripheral surface 4 of the semiconductive roller 1 to form the fluorinated film 5 without influencing the characteristic properties of the crosslinking product of the rubber composition forming the semiconductive roller 1, the treatment temperature is preferably not lower than 0° C. and not higher than 160° C., particularly preferably not lower than 10° C. and not higher than 80° C., in the direct fluorination method. The period for the fluorine gas treatment is preferably not shorter than 1 minute and not longer than 80 minutes.

The gas mixture is preferably used as the gas. The concentration of the fluorine gas in the gas mixture is preferably not lower than 0.1 vol % and not higher than 40 vol %, particularly preferably not lower than 4 vol % and not higher than 20 vol %.

The concentration of the fluorine gas is influenced by the surface area of the product to be treated in the chamber. The greater the surface area of the product to be treated in the chamber, the greater the amount of the fluorine gas to be consumed by the reaction. Therefore, it is necessary to increase the concentration of the fluorine gas in order to uniformly form the fluorinated film.

The concentration of the fluorine gas is not limited to the aforementioned range. Where the fluorine gas is used alone or a gas mixture containing the fluorine gas in a concentration higher than the aforementioned range is used, however, special materials, special devices and a special control operation are required in consideration of the strong corrosiveness and the reactivity of the fluorine gas, resulting in increase in facility costs and reduction in productivity. Further, an excess reaction heat is liable to be generated by the reaction between the rubber surface and the fluorine gas.

If the concentration of the fluorine gas in the gas mixture is lower than the aforementioned range, the formation speed of the fluorinated film is excessively low, requiring an excessively long period for the fluorine gas treatment. This may reduce the productivity of the semiconductive roller.

In the fluorine gas treatment, the treatment temperature, the treatment period and the fluorination intensity may be properly controlled to control the thickness and the like of the fluorinated film 5 according to whether the fluorine gas is used alone or the gas mixture is used and according to the concentration of the fluorine gas in the gas mixture.

<Others>

The inventive semiconductive roller 1 is advantageously used as a developing roller to be incorporated in an electrophotographic image forming apparatus such as a laser printer for developing an electrostatic latent image formed on a surface of a photoreceptor body into a toner image with a charged toner, particularly with a positively chargeable toner.

Where the semiconductive roller 1 is used as the developing roller, for example, the semiconductive roller 1 has a thickness of not less than 0.5 mm and not greater than 10 mm, more preferably not less than 1 mm and not greater than 7 mm, particularly preferably not less than 2 mm and not greater than 5 mm, in order to provide a proper nip width while ensuring size reduction and weight reduction.

The inventive semiconductive roller can be advantageously incorporated in an electrophotographic image forming apparatuses such as a laser printer, an electrostatic copying machine, a plain paper facsimile machine and a printer-copier-facsimile multifunction machine for use as a developing roller as well as a charging roller, a transfer roller, a cleaning roller and the like.

### EXAMPLES

### Example 1

### Preparation of Rubber Composition

A rubber component was prepared by blending 50 parts by mass of a GECO (EPION (registered trade name) 301 available from Daiso Co., Ltd. and having a molar ratio of EO/EP/AGE=73/23/4), 20 parts by mass of a CR (SHOPRENE (registered trade name) WRT available from Showa Denko K.K.) and 30 parts by mass of an NBR (lower acrylonitrile content NBR JSR N250S available from JSR Co., Ltd. and having an acrylonitrile content of 20%).

While 100 parts by mass of the rubber component was simply kneaded by a Banbury mixer, ingredients shown below in Table 1 except a crosslinking component were added to and kneaded with the rubber component. Finally, the crosslinking component was added to and further kneaded with the resulting mixture. Thus, a rubber composition was prepared.

TABLE 1

| Ingredients | Parts by mass |
|---|---|
| Sulfur crosslinking agent | 0.50 |
| Thiuram accelerating agent | 0.50 |
| Thiazole accelerating agent | 0.50 |
| Thiourea accelerating agent | 0.33 |
| Guanidine accelerating agent | 0.28 |
| Acceleration assisting agent | 5.0 |
| Filler I | 2.0 |
| Filler II | 5.0 |
| Acid accepting agent | 3.0 |

The ingredients shown in Table 1 are as follows:

Sulfur crosslinking agent: 5% oil-containing sulfur (available from Tsurumi Chemical Industry Co., Ltd.)
Thiuram accelerating agent: Tetramethylthiuram monosulfide (SANCELER (registered trade name) TS available from Sanshin Chemical Industry Co., Ltd.)
Thiazole accelerating agent: Di-2-benzothiazyl disulfide (SUNSINE MBT (trade name) available from Shandong Shanxian Chemical Co., Ltd.)
Thiourea accelerating agent: Ethylene thiourea (2-mercaptoimidazoline ACCEL (registered trade name) 22-S available from Kawaguchi Chemical Industry Co., Ltd.)
Guanidine accelerating agent: 1,3-di-o-tolylguanidine (SANCELER DT available from Sanshin Chemical Industry Co., Ltd.)
Acceleration assisting agent: ZINC OXIDE TYPE-2 (available from Mitsui Mining & Smelting Co., Ltd.)
Filler I: Carbon black FT (ASAHI #15 available from Asahi Carbon Co., Ltd.)
Filler II: Electrically conductive carbon black (DENKA BLACK (registered trade name) particles available from Denki Kagaku Kogyo K.K.)
Acid accepting agent: Hydrotalcites (DHT-4A (registered trade name) 2 available from Kyowa Chemical Industry Co., Ltd.)

The amounts (parts by mass) of the ingredients shown in Table 1 are based on 100 parts by mass of the overall rubber component.

### (Production of Semiconductive Roller)

The rubber composition thus prepared was fed into the extruder, and extruded into a tubular body having an outer diameter of 20 mm and an inner diameter of 7.0 mm. Then, the tubular body was fitted around a temporary crosslinking shaft, and crosslinked at 160° C. for 1 hour in a vulcanization can.

Subsequently, the crosslinked tubular body was removed from the temporary shaft, then fitted around a shaft having an outer diameter of 7.5 mm and an outer peripheral surface to which an electrically conductive thermosetting adhesive agent was applied, and heated at 160° C. in an oven. Thus, the tubular body was bonded to the shaft. Thereafter, opposite end portions of the tubular body were cut, and the outer peripheral surface of the tubular body was polished by a traverse polishing process utilizing a cylindrical polisher to be thereby mirror-finished as having an outer diameter of 16.00 mm (with a tolerance of 0.05). Thus, a semiconductive roller unified with the shaft was produced.

### (Fluorination)

After the polished outer peripheral surface of the semiconductive roller was rinsed with water and dried, the semiconductive roller was set in a closed chamber with the shaft supported by the chamber, and the chamber was evacuated by means of a vacuum pump. Then, dry nitrogen gas was fed into the chamber, which was in turn evacuated again.

A gas mixture containing 4.4 vol % fluorine gas and 95.6 vol % nitrogen gas was fed into the chamber to be kept in contact with the semiconductive roller 1 at a temperature of 23° C. for 1 hour for fluorine gas treatment. Thus, a semiconductive roller having a fluorinated film formed in its outer peripheral surface was produced.

### Example 2

A semiconductive roller having a fluorinated film formed in its outer peripheral surface was produced in substantially the same manner as in Example 1, except that a treatment temperature of 60° C. and a treatment period of 1 hour were employed for the fluorine gas treatment.

### Example 3

A semiconductive roller having a fluorinated film formed in its outer peripheral surface was produced in substantially the same manner as in Example 1, except that a treatment temperature of 90° C. and a treatment period of 1 hour were employed for the fluorine gas treatment.

### Example 4

A semiconductive roller having a fluorinated film formed in its outer peripheral surface was produced in substantially the same manner as in Example 1, except that a treatment temperature of 120° C. and a treatment period of 1 hour were employed for the fluorine gas treatment.

### Comparative Example 1

The semiconductive roller not formed with the fluorinated film in its outer peripheral surface before the fluorine gas treatment in Example 1 was employed as a semiconductive roller in Comparative Example 1.

### Example 5

A rubber composition was prepared in substantially the same manner as in Example 1, except that 30 parts by mass of the epichlorohydrin rubber, 10 parts by mass of the CR and 60 parts by mass of the NBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Example 6

A rubber composition was prepared in substantially the same manner as in Example 1, except that 30 parts by mass of the epichlorohydrin rubber, 20 parts by mass of the CR and 50 parts by mass of the NBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Example 7

A rubber composition was prepared in substantially the same manner as in Example 1, except that 40 parts by mass of the epichlorohydrin rubber, 20 parts by mass of the CR and 40 parts by mass of the NBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Example 8

A rubber composition was prepared in substantially the same manner as in Example 1, except that 60 parts by mass of the epichlorohydrin rubber, 20 parts by mass of the CR and 20 parts by mass of the NBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Comparative Example 2

The semiconductive roller not formed with the fluorinated film in its outer peripheral surface before the fluorine gas treatment in Example 5 was employed as a semiconductive roller in Comparative Example 2.

### Conventional Example 1

A rubber composition was prepared in substantially the same manner as in Example 1, except that 40 parts by mass of the epichlorohydrin rubber and 60 parts by mass of the NBR were used and the CR was not blended. Then, a semiconductive roller was produced by using the rubber composition thus prepared, and subjected to the fluorine gas treatment under the same conditions as in Example 4. Thus, a semiconductive roller having a fluorinated film formed in its outer peripheral surface was produced.

<Evaluation for Toner Charging Level>

The semiconductive rollers produced in Examples, Comparative Examples and Conventional Example were each mounted in place of an original developing roller in a new cartridge (in which a photoreceptor body, a developing roller and a toner container containing a toner are integrally incorporated) for a commercially available laser printer. The laser printer employs a positively-chargeable single-component nonmagnetic toner of a pulverized type, and has a toner-specific recommended printable number of 8000 (as determined with A4-size paper sheets in conformity with Japanese Industrial Standards JIS X6932:2008 and disclosed)

Then, the cartridge was mounted in the laser printer, and an intermittent sheet passage operation was performed in a higher-temperature and higher-humidity environment at a temperature of 30° C. at a relative humidity of 80% 1500 times a day. In the intermittent sheet passage operation, a 5%-density image was formed every 15 seconds, i.e., the image formation was performed after a lapse of a predetermined stop period from completion of the previous image formation. An image formed on a sheet in the last image formation when the toner was used up was visually checked based on the following criteria for evaluation of the semiconductive roller against reduction of toner charging level.

Level 1: No fogging was observed on the entire sheet surface, or hardly perceivable slight fogging was present on a peripheral portion of the sheet surface. The semiconductive roller was regarded as excellent substantially without reduction of toner charging level (⊚).
Level 2: Slight fogging was observed on a peripheral portion of a sheet surface. The semiconductive roller was regarded as acceptable with slight reduction of toner charging level (∘).
Level 3: Apparent fogging was observed on a peripheral portion of a sheet surface. The semiconductive roller was regarded as unacceptable with reduction of toner charging level (x).
Level 4: Slight fogging was observed on the entire sheet surface. The semiconductive roller was regarded as unacceptable with reduction of toner charging level (x).
Level 5: Apparent fogging was observed on the entire sheet surface. The semiconductive roller was regarded as unacceptable with significant reduction of toner charging level (x).

The results are shown in Tables 2 and 3.

TABLE 2

| Comparative | Example | Example | Example | Example |
|---|---|---|---|---|
| Example 1 | 1 | 2 | 3 | 4 |

Parts by mass

| | | | | | |
|---|---|---|---|---|---|
| GECO | 50 | 50 | 50 | 50 | 50 |
| CR | 20 | 20 | 20 | 20 | 20 |
| NBR | 30 | 30 | 30 | 30 | 30 |

Fluorine gas treatment

| | | | | | |
|---|---|---|---|---|---|
| Temperature | — | 23 | 60 | 90 | 120 |
| (° C.) | | | | | |
| Period (hr) | — | 1 | 1 | 1 | 1 |

Toner charging level

| | | | | | |
|---|---|---|---|---|---|
| Level | 3 | 2 | 2 | 1 | 1 |
| Evaluation | x | ∘ | ∘ | ⊚ | ⊚ |

TABLE 3

| | | | | | |
|---|---|---|---|---|---|
| Comparative | | | | | Conventional |
| Example 2 | Example 5 | Example 6 | Example 7 | Example 8 | Example 1 |

Parts by mass

| | | | | | | |
|---|---|---|---|---|---|---|
| GECO | 30 | 30 | 30 | 40 | 60 | 40 |
| CR | 10 | 10 | 20 | 20 | 20 | — |
| NBR | 60 | 60 | 50 | 40 | 20 | 60 |

Fluorine gas treatment

| | | | | | | |
|---|---|---|---|---|---|---|
| Temperature (° C.) | — | 23 | 23 | 23 | 23 | 120 |
| Period (hr) | — | 1 | 1 | 1 | 1 | 1 |

Toner charging level

| | | | | | | |
|---|---|---|---|---|---|---|
| Level | 4 | 2 | 2 | 2 | 2 | 3 |
| Evaluation | x | ∘ | ∘ | ∘ | ∘ | x |

The results for Examples 1 to 8 and Comparative Examples 1 and 2 in Tables 2 and 3 indicate that the semiconductive rollers each having the fluorinated film formed in the outer peripheral surface thereof by the fluorine gas treatment prevent the significant reduction of the toner charging level after the continuous repeated image formation to thereby suppress the fogging of formed images for a longer period of time.

The results for Examples 1 to 8 and Conventional Example 1 according to Patent Document 1 indicate that the CR should be used in addition to the epichlorohydrin rubber and the NBR as the rubber component for the semiconductive roller in order to provide the aforementioned effects.

The results for Examples 1 to 4 indicate that the temperature for the fluorine gas treatment is preferably increased for further improvement of the aforementioned effects.

The results for Examples 1 to 8 indicate that, where the aforementioned three types of rubbers are used in combination as the rubber component, the proportion of the epichlorohydrin rubber is preferably not less than 30 parts by mass and not greater than 70 parts by mass based on 100 parts by mass of the overall rubber component, and the proportion of the CR is preferably not less than 10 parts by mass and not greater than 30 parts by mass based on 100 parts by mass of the overall rubber component.

### Example 9

A rubber component was prepared by blending 20 parts by mass of a GECO (EPION (registered trade name) 301 available from Daiso Co., Ltd. and having a molar ratio of EO/EP/AGE=73/23/4), 10 parts by mass of a CR (SHOPRENE (registered trade name) WRT available from Showa Denko K.K.) and 70 parts by mass of an SBR (non-oil-extension type JSR1502 available from JSR Co., Ltd. and having a combined styrene amount of 23.5%).

While 100 parts by mass of the rubber component was simply kneaded by a Banbury mixer, ingredients shown below in Table 4 except a crosslinking component were added to and kneaded with the rubber component. Finally, the crosslinking component was added to and further kneaded with the resulting mixture. Thus, a rubber composition was prepared.

TABLE 4

| Ingredients | Parts by mass |
|---|---|
| Sulfur crosslinking agent | 1.05 |
| Thiuram accelerating agent | 0.50 |
| Thiazole accelerating agent | 1.50 |
| Thiourea accelerating agent | 0.33 |
| Guanidine accelerating agent | 0.28 |
| Acceleration assisting agent | 5.0 |
| Filler I | 10.0 |
| Filler II | 2.0 |
| Acid accepting agent | 3.0 |

The ingredients shown in Table 4 are the same as those shown in Table 1.

A semiconductive roller was produced in substantially the same manner as in Example 1 by using the rubber composition thus prepared, and subjected to the fluorine gas treatment under the same conditions as in Example 1. Thus, a semiconductive roller having a fluorinated film formed in its outer peripheral surface was produced.

### Example 10

A semiconductive roller having a fluorinated film formed in its outer peripheral surface was produced in substantially the same manner as in Example 9, except that the fluorine gas treatment was performed under the same treatment conditions as in Example 2.

### Example 11

A semiconductive roller having a fluorinated film formed in its outer peripheral surface was produced in substantially the same manner as in Example 9, except that the fluorine gas treatment was performed under the same treatment conditions as in Example 3.

### Example 12

A semiconductive roller having a fluorinated film formed in its outer peripheral surface was produced in substantially the same manner as in Example 9, except that the fluorine gas treatment was performed under the same treatment conditions as in Example 4.

### Comparative Example 3

The semiconductive roller not formed with the fluorinated film in its outer peripheral surface before the fluorine gas treatment in Example 9 was employed as a semiconductive roller in Comparative Example 3.

### Example 13

A rubber composition was prepared in substantially the same manner as in Example 9, except that 40 parts by mass of the epichlorohydrin rubber, 20 parts by mass of the CR and 40 parts by mass of the SBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Example 14

A rubber composition was prepared in substantially the same manner as in Example 9, except that 50 parts by mass of the epichlorohydrin rubber, 10 parts by mass of the CR and 40 parts by mass of the SBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Example 15

A rubber composition was prepared in substantially the same manner as in Example 9, except that 40 parts by mass of the epichlorohydrin rubber, 10 parts by mass of the CR and 50 parts by mass of the SBR were used. Then, a semiconductive roller was produced by using the rubber composition thus prepared, and subjected to the fluorine gas treatment under the same conditions as in Example 1. Thus, a semiconductive roller having a fluorinated film formed in its outer peripheral surface was produced.

### Comparative Example 4

A rubber composition was prepared in substantially the same manner as in Example 9, except that 30 parts by mass of the epichlorohydrin rubber and 70 parts by mass of the SBR were used and the CR was not blended. Then, a semiconductive roller was produced by using the rubber composition thus prepared, and subjected to the fluorine gas treatment under the same conditions as in Example 4. Thus, a semiconductive roller having a fluorinated film formed in its outer peripheral surface was produced.

The semiconductive rollers produced in Examples and Comparative Examples were evaluated for the toner charging level in the aforementioned manner. The results are shown in Tables 5 and 6.

TABLE 5

| Comparative | Example | Example | Example | Example |
|---|---|---|---|---|
| Example 3 | 9 | 10 | 11 | 12 |

Parts by mass

| | | | | | |
|---|---|---|---|---|---|
| GECO | 20 | 20 | 20 | 20 | 20 |
| CR | 10 | 10 | 10 | 10 | 10 |
| SBR | 70 | 70 | 70 | 70 | 70 |

Fluorine gas treatment

| | | | | | |
|---|---|---|---|---|---|
| Temperature | — | 23 | 60 | 90 | 120 |
| (° C.) | | | | | |
| Period (hr) | — | 1 | 1 | 1 | 1 |

Toner charging level

| | | | | | |
|---|---|---|---|---|---|
| Level | 3 | 2 | 2 | 1 | 1 |
| Evaluation | x | ∘ | ∘ | ⊚ | ⊚ |

TABLE 6

| Example | Example | Example | Comparative |
|---|---|---|---|
| 13 | 14 | 15 | Example 4 |

Parts by mass

| | | | | |
|---|---|---|---|---|
| GECO | 40 | 50 | 40 | 30 |
| CR | 20 | 10 | 10 | — |
| SBR | 40 | 40 | 50 | 70 |

Fluorine gas treatment

| | | | | |
|---|---|---|---|---|
| Temperature | 23 | 23 | 23 | 120 |
| (° C.) | | | | |
| Period (hr) | 1 | 1 | 1 | 1 |

Toner charging level

| | | | | |
|---|---|---|---|---|
| Level | 2 | 2 | 2 | 3 |
| Evaluation | ∘ | ∘ | ∘ | x |

The results for Examples 9 to 15 and Comparative Example 3 in Tables 5 and 6 indicate that the semiconductive rollers each formed from the SBR-containing rubber composition and having the fluorinated film formed in the outer peripheral surface thereof by the fluorine gas treatment also prevent the significant reduction of the toner charging level after the continuous repeated image formation to thereby suppress the fogging of formed images for a longer period of time.

The results for Examples 9 to 15 and Comparative Example 4 indicate that the CR should be used in addition to the epichlorohydrin rubber and the SBR as the rubber component for the semiconductive roller in order to provide the aforementioned effects.

The results for Examples 9 to 12 indicate that the temperature for the fluorine gas treatment is preferably increased for further improvement of the aforementioned effects.

The results for Examples 9 to 15 indicate that, where the aforementioned three types of rubbers are used in combination as the rubber component, the proportion of the epichlorohydrin rubber is preferably not less than 20 parts by mass and not greater than 60 parts by mass based on 100 parts by mass of the overall rubber component, and the proportion of the CR is preferably not less than 10 parts by mass and not greater than 30 parts by mass based on 100 parts by mass of the overall rubber component.

This application corresponds to Japanese Patent Application No. 2014-095292 filed in the Japan Patent Office on May 2, 2014, the disclosure of which is incorporated herein by reference in its entirety.

What is claimed is:

1. A semiconductive roller made of a crosslinking product of a rubber composition comprising a rubber component including an epichlorohydrin rubber and a chloroprene rubber, and having a fluorinated film formed in an outer peripheral surface thereof by treatment with fluorine gas.

2. The semiconductive roller according to claim 1, wherein the rubber component further includes at least one rubber selected from the group consisting of an acrylonitrile butadiene rubber and a styrene butadiene rubber.

3. The semiconductive roller according to claim 2,
wherein the rubber component includes three types of rubbers including the epichlorohydrin rubber, the chloroprene rubber and the acrylonitrile butadiene rubber,
wherein the epichlorohydrin rubber is present in the rubber composition in a proportion of not less than 30 parts by mass and not greater than 70 parts by mass based on 100 parts by mass of the overall rubber component,
wherein the chloroprene rubber is present in the rubber composition in a proportion of not less than 10 parts by mass and not greater than 30 parts by mass based on 100 parts by mass of the overall rubber component.

4. The semiconductive roller according to claim 2,
wherein the rubber component includes three types of rubbers including the epichlorohydrin rubber, the chloroprene rubber and the styrene butadiene rubber,
wherein the epichlorohydrin rubber is present in the rubber composition in a proportion of not less than 20 parts by mass and not greater than 60 parts by mass based on 100 parts by mass of the overall rubber component,
wherein the chloroprene rubber is present in the rubber composition in a proportion of not less than 10 parts by mass and not greater than 30 parts by mass based on 100 parts by mass of the overall rubber component.

5. The semiconductive roller according to claim 1, which has a non-porous single layer structure.

6. The semiconductive roller according to claim 1, which is incorporated in an electrophotographic image forming apparatus for use as a developing roller for developing an electrostatic latent image formed on a surface of a photoreceptor body into a toner image with a positively chargeable toner.
